(19) United States
(12) Patent Application Publication
(10) Pub. No.: US 2008/0251098 A1
(43) Pub. Date: Oct. 16, 2008

(54) TOOTHPICK WITH BRISTLES

(76) Inventor: Chin-Yen CHEN, Sinjhuang City (TW)

Correspondence Address: SINORICA, LLC, 528 FALLSGROVE DRIVE, ROCKVILLE, MD, 20850, US

(21) Appl. No.: 11/735,458

(22) Filed: Apr. 14, 2007

(51) Int. Cl. A61C 15/02

(52) U.S. Cl. 132/329

(57) ABSTRACT

A toothpick with bristles, the toothpick has a rod being laid out on its surface bristles coated each with a coating layer, the material of the coating layer can be mouth rinsing water, cleaning liquid, toothpaste powder or cooling material. When in clearing filth between teeth, coating layers can give a user a comfortable feeling. And a packing unit is provided for loading therein a plurality of toothpicks with bristles; the packing unit has a receiving space for storing material which can form the coating layers for the bristles of the toothpicks by dipping.

### BACKGROUND OF THE INVENTION

1. Field of the invention

The present invention is related to a toothpick with bristles, and especially to a toothpick with bristles coated each with a coating layer.

2. Description of the Prior Art

Toothpicks with bristles are used to clear accumulated filth between teeth to thereby get an effect of health care of teeth; and this has been a conventional practice. A conventional toothpick with bristles has a slim and elongate rod being laid out on its surface bristles. By protruding outwards of the bristles, the toothpick can get a better filth removing effect than a conventional toothpick without bristle. However, such a toothpick with bristles can not help touching sensitive gums and make a person uncomfortable; this situation needs to be improved.

### SUMMARY OF THE INVENTION

Therefore, the present invention mainly provides a toothpick with bristles; the toothpick has a rod being laid out on its surface bristles coated each with a coating layer. The material of the coating layer can be mouth rinsing water, cleaning liquid, toothpaste powder or cooling material. The coating layers can give a user a comfortable feeling.

Moreover, the present invention provides a packing unit for loading therein a plurality of toothpicks with bristles; the packing unit has a sheet member with a plurality of check like receivers for loading the toothpicks with bristles and a receiving space for storing material forming coating layers of the toothpicks with bristles. When the coating layers of the toothpicks disappear in using, further coating layers can be supplemented from the receiving space to get a good effect of application.

The surfaces of the bristles on the toothpicks with the bristles loaded in the check like receivers can also have no coating layer; when in using, the bristles can be contacted with the material in the receiving space by dipping to form the coating layers. And this is another mode of practicing for the packing unit.

The present invention will be apparent in its structure and effect after reading the detailed description of the preferred embodiment thereof in reference to the accompanying drawings.

### BRIEF DESCRIPTION OF THE DRAWINGS

FIG. 1 is a perspective view showing the appearance of a toothpick with bristles of the present invention;

FIG. 2 is an enlarged perspective view showing a part “A” in FIG. 1;

FIG. 3 is a schematic view showing using of the toothpick with bristles of the present invention;

FIG. 4 is a perspective view showing the appearance of a packing unit for loading therein a plurality of toothpicks with bristles.

### DETAILED DESCRIPTION OF THE PREFERRED EMBODIMENT

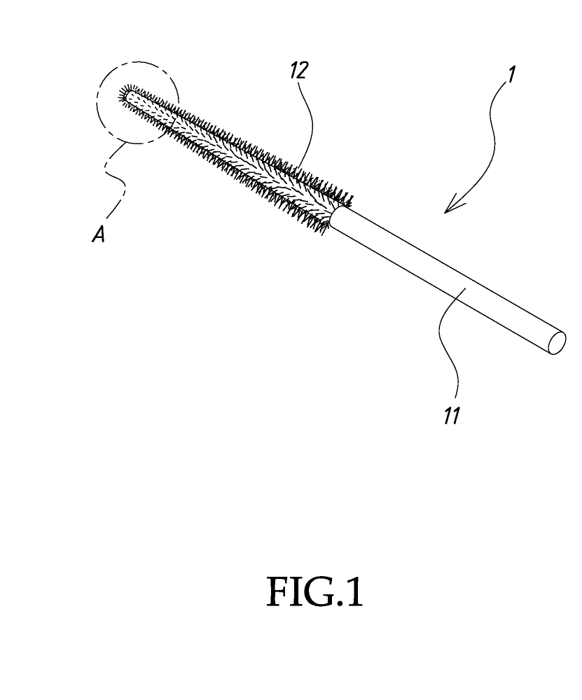

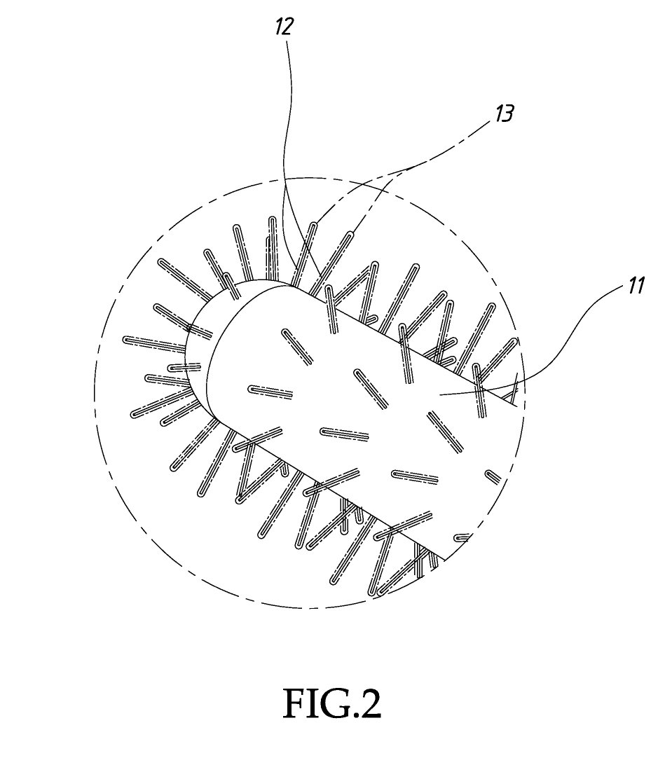

Referring to the FIGS. 1 and 2, a toothpick 1 with bristles of the present invention is composed of a rod 11, bristles 12 and coating layers 13.

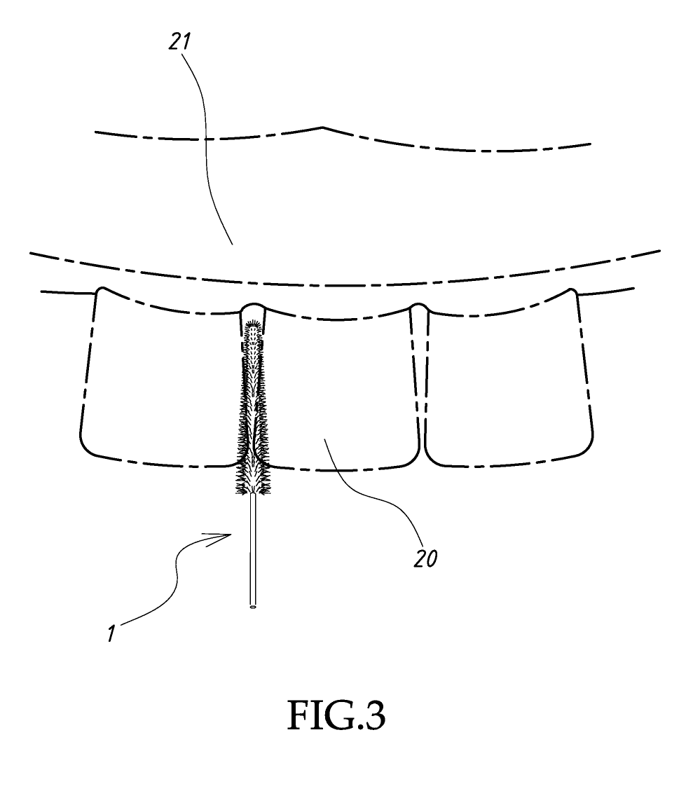

The rod 11 is elongate and able to be extended in between two teeth. The bristles 12 are laid out on the surface of the rod 11; the rod 11 can be made of soft material in favor of insertion of the rod 11 between two teeth 20 as is shown in FIG. 3.

The present invention is to form coating layers 13 on the coating layers 13 as is seen in FIG. 2; material for the coating layers 13 can be selected from mouth rinsing water, cleaning liquid, toothpaste powder or cooling material.

When in using, by the function of the coating layers 13, the present invention can alleviate pain created by contact with a gingival to thereby get an effect of comfort.

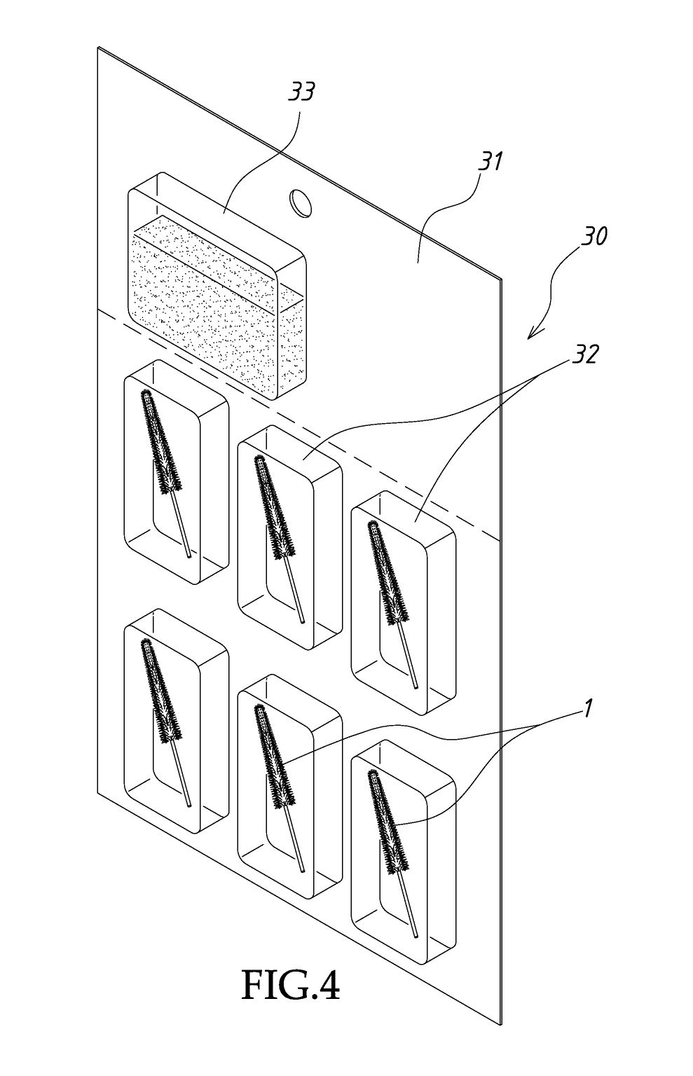

And more, referring to FIG. 4, the present invention provides a packing unit 30 for loading therein a plurality of toothpicks 1 with the bristles 12; the packing unit 30 mainly has a sheet member 31 with a plurality of check like receivers 32 for loading the toothpicks 1 with the bristles 12; the check like receivers 32 are made by injection molding, and the sheet member 31 is of hard fabric material such as paper. In order to allow supplementing of material of the coating layers 13 for the toothpicks 1 with the bristles 12, the sheet member 31 is provided thereon with at least one receiving space 33 also formed injection molding and being an independent check like receiving space, the receiving space 33 is stored therein with the supplementing material for the coating layers 13 such as mouth rinsing water, cleaning liquid, toothpaste powder or cooling material.

By consumption of the coating layers 13 after using many times, the packing unit 30 is designed to have the receiving space 33 in order that a user can contact the bristles 12 of the toothpicks 1 directly with the material in the receiving space 33 to form the coating layers 13.

Surely, the surfaces of the bristles 12 on the toothpicks 1 with the bristles 12 stored in the check like receivers 32 of the packing unit 30 can also have no coating layer 13; when in using, the bristles 12 can be contacted with the material in the receiving space 33 by dipping to form the coating layers 13.

The above stated and depicted are only for illustrating the preferred embodiments the present invention. It will be apparent to those skilled in this art that various modifications or changes can be made to the elements of the present invention without departing from the spirit and scope of this invention, for example, changes in the shapes of the bristles and the rod of a toothpick, or increasing/decreasing of the numbers of the check like receivers and the receiving space on the packing unit, and all such modifications and changes shall also fall within the scope of the appended claims and are intended to form part of this invention.

1. A toothpick with bristles, said toothpick comprises:
a rod;
said bristles, being laid out on a surface of said rod; and
coating layers coating said bristles.

2. The toothpick with bristles as in claim 1, wherein material for said coating layers is selected from mouth rinsing water, cleaning liquid, toothpaste powder or cooling material.

3. A packing unit for loading therein a plurality of toothpicks with bristles, said packing unit comprises:
a sheet member with a plurality of check like receivers;
said toothpicks with said bristles, each of said toothpicks has a rod being laid out on a surface thereof said bristles, said toothpicks with said bristles are loaded in said check like receivers of said sheet member; and
at least a receiving space provided on said sheet member for storing therein with mouth rinsing water, cleaning liquid, toothpaste powder or cooling material to be dipped to form said coating layers on said bristles of said toothpicks.

4. The toothpick with bristles as in claim 3, wherein said bristles of said toothpicks are provided thereon with said coating layers, material for said coating layers is mouth rinsing water, cleaning liquid, toothpaste powder or cooling material.
